(19) United States
(12) Patent Application Publication
(10) Pub. No.: US 2014/0198425 A1
(43) Pub. Date: Jul. 17, 2014

(54) GROUNDING OF A FUEL DELIVERY MODULE BY MEANS OF A SPRAYED-ON ELECTRICALLY CONDUCTIVE STRUCTURE

(71) Applicants: Martin Beyer, Marbach (DE); Alexander Roeck, Stuttgart (DE); Hans-Peter Braun, Renfrizhausen (DE)

(72) Inventors: Martin Beyer, Marbach (DE); Alexander Roeck, Stuttgart (DE); Hans-Peter Braun, Renfrizhausen (DE)

(73) Assignee: ROBERT BOSCH GMBH, Stuttgart (DE)

(21) Appl. No.: 14/342,447

(22) PCT Filed: Jul. 23, 2012
(86) PCT No.: PCT/EP2012/064415

§ 371 Date: Mar. 3, 2014

(30) Foreign Application Priority Data
Sep. 1, 2011 (DE) 10 2011 081 967.3

(51) Int. Cl. H05F 3/02

(52) U.S. Cl. CPC H05F 3/02
USPC 361/215

(57) ABSTRACT

A groundable fuel delivery module (1) for a fuel tank (3) is proposed. Here, the fuel delivery module (1) has a first element (5) composed of non-conductive material. Here, the first element (5) may be for example a tank flange (7) or a filter housing (9). The fuel delivery module (1) furthermore has an electrically conductive structure (11) which is designed to connect the first element (5) to a ground contact (13). Here, the electrically conductive structure (11) is sprayed onto the first element (5) for example by means of a two-component method or by means of a plasma spraying method.

### BACKGROUND OF THE INVENTION

If a liquid flows through a narrow gap or through a component with a small cross section, friction may occur between the component and the liquid. Particularly at high flow rates of the liquid, this may lead to a charge separation, and consequently to an electrostatic charging of the component through which the flow is passing.

In particular in environments with potentially explosive components, such as for example in a fuel tank, it is important to avoid electrostatic discharges, also known as ESDs. Furthermore, an electrostatic discharge must be avoided in order to avoid an undesired influence on surrounding electrical equipment. Furthermore, such an electrostatic discharge should be prevented in order to avoid material wear, known as “pin holing”, being caused by repeated spark discharging at the same point.

In order to avoid electrostatic discharging on a fuel delivery module, plastic elements, such as for example filter housings or flanges, are designed to be conductive, for example by admixing metal particles. However, this may involve considerable expenditure in terms of costs. Electrically conductive elements, such as for example metallic guide rods on a flange, must be laboriously connected by means of cables to electrical interfaces and ground connections to avoid electrostatic discharges. This involves a high degree of expenditure in terms of work and material.

### SUMMARY OF THE INVENTION

There may therefore be a need for an improved design of a fuel delivery module that makes reliable grounding of the fuel delivery module possible and at the same time makes a saving of expenditure in terms of costs, material and work possible.

Features, details and possible advantages of a device according to embodiments of the invention are discussed in detail below.

According to a first aspect of the invention, a groundable fuel delivery module or a fuel delivery unit for use in fuel tanks is presented. The fuel delivery module has a first element, composed of electrically nonconductive material. Furthermore, the fuel delivery module has an electrically conductive structure, which is designed to connect the first element to an electrical ground contact. Here, the conductive structure is sprayed on the first element.

In other words, the concept of the present invention is based on the idea of ensuring grounding of the fuel delivery module by an electrically conductive layer, in particular an electrically conductive strip conductor, being sprayed directly on an electrically nonconductive element, such as for example a flange. This electrically conductive structure is connected to the electrically nonconductive element in a material-bonding manner and designed to carry away charges to an electrical ground contact.

The spray application of the electrically conductive structure to the first, electrically nonconductive element produces a material-bonding connection, so that excess charges that are produced by electrostatic charging of the first element can be carried away. As a result, there is no need for costly additions of material in the first element. At the same time, a grounding of components of the plastic delivery module is ensured.

Furthermore, the electrically conductive structure may be sprayed on in a rib-like or supporting manner. This means that the electrically conductive structure may have a certain material thickness and may contribute to the stiffening of the first element, such as for example a flange. This makes it possible to dispense with stiffening elements and thereby save additional installation space. Furthermore, expenditure in terms of work involved in the integration of stiffening elements can be reduced.

The fuel delivery module may be a unit that can be used in a fuel tank. For example, the fuel delivery module may comprise a tank flange, a fuel pump reservoir, a filter and corrugated tubes. The fuel delivery module may be used for example in motor vehicles, for example with an internal combustion engine.

The first element may for example be a housing, a tank flange, a fuel pump reservoir or a filter or filter element in the fuel delivery module. The first element is in this case made of nonconductive material or comprises an electrically nonconductive material.

Electrically nonconductive materials may be for example nonmetals, hydrocarbons, plastics and organic compounds. The first element may comprise combinations of these materials. The electrical conductivity of the nonconducting materials may in this case be for example less than 10-8 Siemens per meter.

An electrically conductive structure is sprayed directly on the first element. The electrically conductive structure is designed to transport away charges from the first element, and possibly from assigned conductive components. In particular, the electrically conductive structure may connect the first element to a ground contact, such as for example a negative terminal of an energy source or, in the example of a vehicle, to the vehicle body. In this way, the first element, and all conductive components connected to the first element, are grounded by means of the electrically conductive structure.

The electrically conductive structure may for example be designed as a thin layer and cover part of the surface of the first element or the complete first element. Alternatively, the electrically conductive structure may be designed as a thin strip conductor or rail. The electrically conductive structure may also be applied to the first element in the form of a network. The electrically conductive structure comprises a conductive material, such as for example metal, carbon or conductive particles or fibers.

The electrically conductive structure is sprayed on the first element. That is to say that a material-bonding connection is established between the electrically conductive structure and the first element. For example, the electrically conductive structure may be fused and/or chemically bonded to the first element. Here, the electrically conductive structure may be applied to the first element for example by means of a two-component spraying method or by means of a plasma spraying method.

According to an exemplary embodiment of the invention, the fuel delivery module has a second element, composed of conductive material. The conductive structure is designed here to connect the second element to the ground contact.

The second element may consist of conductive material or comprise conductive material. For example, the second element may be a guide rod on a tank flange. Furthermore, the second element may be a pressure regulator. Furthermore, the second element may be any desired element in the fuel delivery module that is electrically conductive. For example, the second element may comprise metal or carbon. With the aid of the electrically conductive structure, the second element can be connected to electrical interfaces. Furthermore, by means of the electrically conductive structure, the second element can be electrically bonded and connected to a ground contact. This dispenses with the need for cabling. Here, the second element may be grounded at the same ground contact as the first element or at a further ground contact.

Furthermore, the grounding of the fuel delivery module becomes more reliable and less susceptible to faults. This is achieved by faults such as fallen-off contacts, which can occur for example due to vibrations or assembly errors, being avoided.

According to a further exemplary embodiment of the invention, the electrically conductive structure is sprayed on the first element by a two-component spraying method.

The two-component spraying is also referred to as two-component injection molding and describes a method in which initially a first element is injection-molded in a mold. This may for example involve using plastic, in particular granules of plastic, such as for example POM. Once the first element has cured or has reached a certain degree of hardness or certain cooling temperature, the electrically conductive structure is sprayed on. The electrically conductive structure may comprise here for example the same plastic as the first element. Furthermore, conductive fibers or particles may be additionally admixed with the plastic.

According to a further exemplary embodiment of the invention, the conductive structure is sprayed on the first element by means of a plasma spraying method.

The plasma spraying method may be a chemical- and mask-free method, as presented for example in DE 10 2006 061 435 A1. For example, the plasma spraying method may also be referred to as the “Leoni” Flamecon® spray application method. By means of the plasma spraying method it is possible for example for metallic materials to be applied in structured layers in particular, to insulating support materials or substrates, by generating a plasma beam. Here, the support material is the first element, composed of electrically nonconductive material.

The spraying device may for example be a plasma gun. In this case, the solder material is heated by a plasma beam and accelerated in the direction of the surface of the component, until it impinges there.

Before the spray application or spraying on by means of a plasma beam, the conductive material may be in the form of a powder or in the form of small spheres. The powder elements or the spheres of the electrically conductive material may be accelerated onto the surface of the first element for example by means of a plasma beam gun in the form of a focused beam.

The application of the electrically conductive structure with the aid of a plasma spraying method has the effect that the surface of the first element is not damaged and remains intact. The minimal amount of heat that is thereby introduced by the plasma flame is so small that the material of the first element is not affected. Furthermore, the plasma spraying method may have 3D capability. In other words, the mobility of the plasma spraying device, such as for example a plasma spray gun, is possible in three dimensions. This can contribute to being able to apply fine structures of the electrically conductive structure even at points of the first element that are difficult to access.

According to a further exemplary embodiment of the invention, the electrically conductive structure comprises an electrically conductive plastic or metal. In particular in the case of the spray application of the electrically conductive structure by means of the two-component spraying method, the electrically conductive structure may comprise an electrically conductive plastic. In this case, the plastic used in the first spraying step of the two-component spraying method may be provided with conductive particles in the second spraying step. During the spray application of the electrically conductive structure by means of the plasma spraying method, metal particles or metal fibers may be sprayed onto the first element as the electrically conductive structure. The electrically conductive structure may consist completely of an electrically conductive plastic or of metal.

According to a further exemplary embodiment of the invention, the first element is designed as a tank flange, filter housing, ejector pump or the electrically nonconductive housing thereof or as a hydraulic line, in particular as a corrugated tube. These components may be made as plastic components.

According to a second aspect of the invention, a method for producing a groundable fuel delivery module described above for fuel tanks is described. The method comprises the following steps: providing a first element of the fuel delivery module, composed of nonconductive material; spray application of an electrically conductive structure, which is designed to connect the first element to a ground.

According to an exemplary embodiment of the invention, a plasma spraying method is used for the spray application of the electrically conductive structure.

According to a further exemplary embodiment of the invention, the first element is provided by a first step of a two-component spraying method; the electrically conductive structure is thereby sprayed on by a second step of a two-component spraying method.

### BRIEF DESCRIPTION OF THE DRAWINGS

Further features and advantages of the present invention are evident to a person skilled in the art from the following description of embodiments given by way of example, which however are not to be interpreted as restricting the invention, with reference to the accompanying drawings.

FIG. 1 shows a perspective view of a filter according to the prior art

FIG. 2 shows a perspective view of a tank flange according to the prior art

FIG. 3 shows a perspective view of a first element of a fuel delivery module according to a first exemplary embodiment of the invention

FIG. 4 shows a perspective section through the first element shown in FIG. 3, along line A-A

FIG. 5 shows a filter in the fuel pump reservoir according to a second exemplary embodiment of the invention

FIG. 6 shows the arrangement of the first and second elements in a fuel delivery module according to a further exemplary embodiment of the invention.

### DETAILED DESCRIPTION

All of the figures are merely schematic representations of devices according to the invention or the component parts thereof according to exemplary embodiments of the invention. Distances and relative sizes in particular are not reproduced to scale in the figures. In the various figures, corresponding elements have been provided with the same reference numerals.

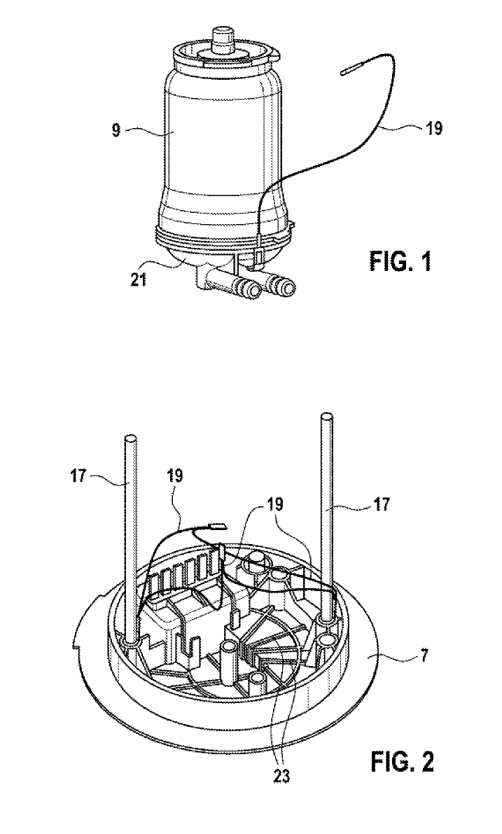

FIG. 1 and FIG. 2 show previously customary embodiments of first elements 5. In FIG. 1, the first element 5 is designed as a filter and is represented in a perspective view. The filter has a filter housing 9 and a filter cover 21. To avoid electrostatic charging and uncontrolled discharging, the filter or the filter housing 9 must be grounded with the aid of a cable 19.

In FIG. 2 the first element is designed as a flange, in particular as a tank flange for use in a fuel tank. The tank flange 7 has reinforcing profiles 23, which contribute to the stability of the tank flange. Also represented in FIG. 2 is a second, electrically conductive element 15 in the form of guide rods 17. The guide rods 17 are arranged on the flange and designed for example to guide a fuel pump reservoir to the bottom of a fuel tank. The flange, and in particular also the guide rods 17, must be grounded with the aid of a cable 19. Grounding with the aid of the cable 19 may be complex and labor-intensive. Furthermore, for this purpose components, such as for example the guide rods 17, must be provided with interfaces for electrical bonding.

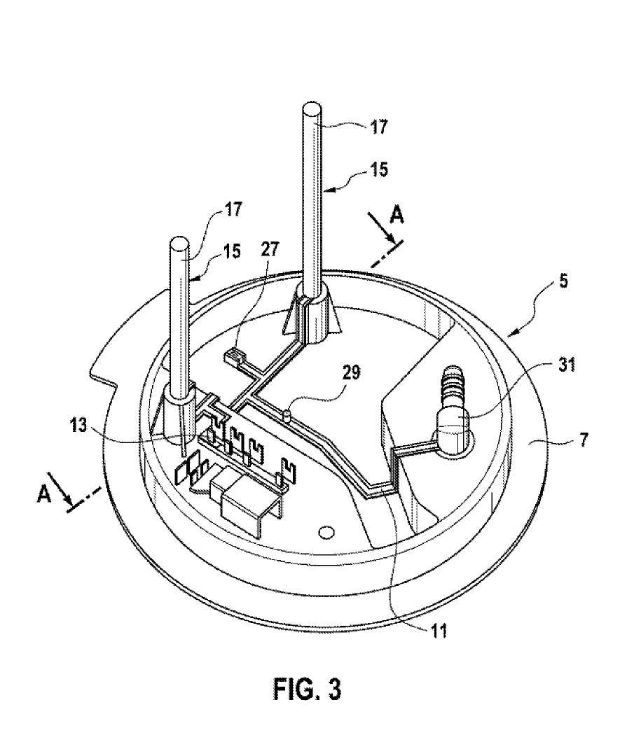

The groundable fuel delivery module 1 according to the invention, represented in FIGS. 3 to 6, or the components thereof offer(s) a technically simpler possible way of avoiding electrostatic discharges, which is both less costly than the known fuel delivery modules and can reduce the required expenditure in terms of work and material.

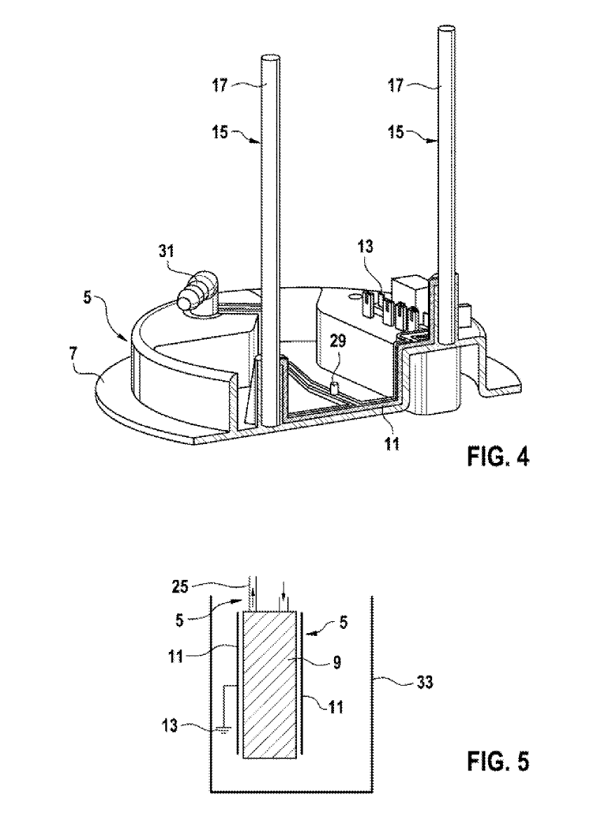

In FIGS. 3 and 4, the first element 5 of the fuel delivery module 1 is designed as a tank flange 7. The second element 15 is designed here as a guide rod 17. Furthermore, in FIGS. 3 and 4 the electrically conductive structure 11 is designed as a conductor rail, for example composed of conductive plastic, sprayed on by means of a two-component spraying method.

In FIG. 3, the first element 5 or the tank flange 7 is produced from nonconductive material, such as for example plastic, and provided with an electrically conductive structure 11. Here, the electrically conductive structure 11 can carry away all of the charges produced at the tank flange 7 to the ground contact 13, for example to an interface that is connected to a negative terminal of an electrical energy source or a vehicle body. Furthermore, the second, electrically conductive element 15, which is designed in FIG. 3 as guide rods 17, is connected to the ground contact 13 by means of the electrically conductive structure 11.

The conductor rail sprayed on by means of the two-component spraying method in FIG. 3 may be designed in a rib-like manner and serve for stiffening the tank flange 7. In this way, there may be no need for strengthening profiles 23. Furthermore, the electrically conductive structure 11 also offers the possibility of designing optional interfaces for the electrical bonding of various component parts of the fuel delivery module 1. For example, a receptacle 27 for a pressing contact may be provided on the electrically conductive structure 11. This receptacle may be an interface between electrically conductive components of the fuel delivery module 1 and possibly electrical power sources. Furthermore, a receptacle 29 for a crimp-contact element may be provided on the electrically conductive structure 11. This receptacle 29 may for example be designed as a pin and for example establish contact with a cable lug of a filter cover 21. The electrically conductive structure 11 may also ground further components, such as for example a connection piece 31 or an insert of conductive material. In this way, a hydraulic line, for example a conductive corrugated tube, can be grounded.

In FIG. 4, a perspective sectional view along the line A-A from FIG. 3 is represented. Here, the rib-like configuration of the conductor rail or the electrically conductive structure 11 is illustrated. The electrically conductive structure 11 may for example also be designed as running around the guide rods 17. The direct spray application of the electrically conductive structure 11 onto the tank flange 7 allows faults, such as fallen-off contacts, which are caused for example by vibrations or assembly errors, to be avoided.

In FIG. 5, the first element 5, which is intended to be grounded, is represented as a filter housing 9. The electrically conductive structure 11 is designed in FIG. 5 as a conductive layer on the surface of a filter housing 9, which is sprayed on with the aid of a plasma spraying method.

FIG. 5 shows a fuel pump reservoir 33 and a filter arranged therein with a filter housing 9. In the exemplary embodiment in FIG. 5, the filter housing 9 is provided with an electrically conductive structure 11 by means of a plasma spraying method. Similarly, for example, the corrugated tubes 25 may be provided with the electrically conductive structure 11.

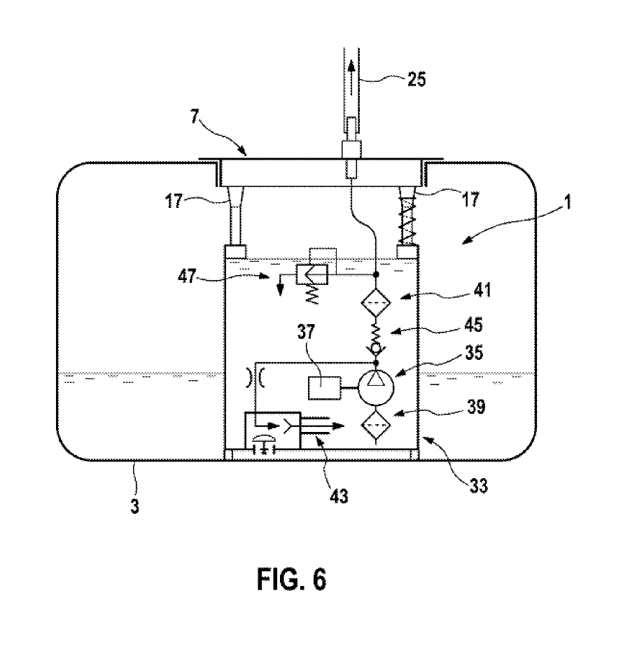

FIG. 6 shows a fuel delivery module 1, which is arranged in a fuel tank 3. The fuel delivery module 1 has a fuel pump reservoir 33. Provided in the fuel pump reservoir 33 are a number of first elements 5, on which an electrically conductive structure 11 may be sprayed. Provided for example is an ejector pump 43, which fills the fuel pump reservoir 33 with fuel. Furthermore, the fuel delivery module 1 has a tank flange 7 with guide rods 17, which are connected by way of the electrically conductive structure 11 (not shown in FIG. 6) to a ground contact 13 (not shown in FIG. 6). The tank flange 7 is connected by way of the guide rods 17 to the fuel pump reservoir 33. The fuel from the fuel tank 3 is delivered with the aid of a pump 35 with a pump motor 37 from the fuel pump reservoir 33, for example by way of hydraulic lines 25, in particular by way of corrugated tubes, to the injection system of an internal combustion engine. Provided upstream of the pump 35 is a prefilter 39. Arranged downstream of the pump 35 is a check valve 45 and a fine filter 41. Both the housing 9 of the prefilter 39 and the housing 9 of the fine filter 41 may be provided with an electrically conductive structure 11, as shown in FIG. 5. Also provided in the fuel pump reservoir 33 is a pressure regulator 47, the housing of which may likewise be provided with the electrically conductive structure 11.

Consequently, in FIG. 6 the first elements 5 are designed as a tank flange 7, filter housing 9, ejector pump 43, housing of a pressure regulator 47 and as a hydraulic line 25. By spray application of the electrically conductive structure 11 to these first elements 5, they can be connected to a ground contact 13 for carrying away electrostatic charges. Furthermore, already existing structures, such as for example the second elements 15, for example guide rods 17, can in this way be electrically bonded without additional expenditure in terms of cabling.

Finally, it is noted that expressions such as “having” or “comprising” or the like are not intended to rule out the possibility that further elements or steps may be provided. Furthermore, it should be pointed out that “a” or “an” does not rule out a multiplicity. Also, features described in conjunction with the various embodiments may be combined with one another in any way desired. It is also noted that the reference numerals in the claims are not intended to be interpreted as restricting the scope of the claims.

1. A groundable fuel delivery module (1) for fuel tanks (3), the fuel delivery module (1) comprising
a first element (5), composed of electrically nonconductive material; and
an electrically conductive structure (11), which is configured to connect the first element (5) to a ground contact (13);
characterized in that the conductive structure (11) is sprayed on the first element (5).

2. The fuel delivery module (1) as claimed in claim 1, also comprising a second element (15), composed of electrically conductive material; wherein
the electrically conductive structure (11) is configured to connect the second element (15) to the ground contact (13).

3. The fuel delivery module (1) as claimed in claim 1, the electrically conductive structure (11) being sprayed on the first element (5) by means of a two-component spraying method.

4. The fuel delivery module (1) as claimed in claim 1, the electrically conductive structure (11) being sprayed on the first element (5) by means of a plasma spraying method.

5. The fuel delivery module (1) as claimed in claim 1, the electrically conductive structure (11) comprising an electrically conductive plastic or a metal.

6. The fuel delivery module (1) as claimed in claim 1, the first element (5) being one of a tank flange (7), a filter housing (9), an ejector pump (43), a pressure regulator housing (47) and a hydraulic line (25).

7. A method for producing a groundable fuel delivery module (1) for fuel tanks (3), as claimed in claim 1, the method comprising the following steps
providing the first element (5) of the fuel delivery module (1), composed of electrically nonconductive material; and
spraying the electrically conductive structure (11), which is configured to connect the first element (5) to a ground contact (13), onto the first element.

8. (canceled)

9. The method as claimed in claim 7, the first element (5) being provided by a first step of a two-component spraying method;
the electrically conductive structure (11) being sprayed on by a second step of a two-component spraying method.

10. The method as claimed in claim 7, wherein the fuel delivery module also comprises a second element (15), composed of electrically conductive material; wherein
the electrically conductive structure (11) is configured to connect the second element (15) to the ground contact (13).

11. The method as claimed in claim 7, wherein the electrically conductive structure (11) is sprayed on the first element (5) by means of a two-component spraying method.

12. The method as claimed in claim 7, wherein the electrically conductive structure (11) is sprayed on the first element (5) by means of a plasma spraying method.

13. The method as claimed in claim 7, wherein the electrically conductive structure (11) comprises an electrically conductive plastic or a metal.

14. The method as claimed in claim 7, wherein the first element (5) is one of a tank flange (7), a filter housing (9), an ejector pump (43), a pressure regulator housing (47) and a hydraulic line (25).
